(19) United States
(12) Patent Application Publication
(10) Pub. No.: US 2012/0143873 A1
(43) Pub. Date: Jun. 7, 2012

(54) METHOD AND APPARATUS FOR UPDATING A PARTITIONED INDEX

(75) Inventor: Saied Saadat, Watertown, MA (US)

(73) Assignee: Nokia Corporation, Espoo (FI)

(21) Appl. No.: 13/308,095

(22) Filed: Nov. 30, 2011

Related U.S. Application Data
(60) Provisional application No. 61/418,258, filed on Nov. 30, 2010.

(51) Int. Cl. G06F 17/30

(52) U.S. Cl. 707/741; 707/E17.002; 707/E17.005

(57) ABSTRACT

Techniques for enhanced updating of a partitioned index include first data that indicates a plurality of fields for each entry in an index for a data store. A current number of partitions for the index is determined. Second data that indicates at least one value for at least one field of at least a first entry in the index is received. A next number of partitions for the index based on the second data is determined automatically.

### RELATED APPLICATIONS

This application claims the benefit of the earlier filing date under 35 U.S.C. §119(e) of U.S. Provisional Application Ser. No. 61/418,258 filed Nov. 30, 2010, entitled “Method and Apparatus for Updating a Partitioned Index,” the entirety of which is incorporated herein by reference.

### BACKGROUND

Service providers (e.g., wireless, cellular, etc.) and device manufacturers are continually challenged to deliver value and convenience to consumers by, for example, providing compelling network services. Important differentiators in the industry are application and network services as well as capabilities to support and scale these services. In particular, these applications and services can include accessing and managing data utilized by network services. These services entail managing a tremendous amount of user data, such as terabytes of data available through online stores for books, audio and video or online storage of personal emails, pictures, audio and video for a large number of subscribers. To search these large data holdings, indices are generated that associate data objects like books and images and files with searchable fields, such as dates and subject matter. The indices themselves can become quite large. Some services store such indices distributed among many network nodes so that each node maintains an index of a size that can be searched in a reasonably short time. As data is added to the data holdings the indices are also updated. However, some updates can consume large amounts of computational power and network bandwidth, especially as index is re-partitioned, with inherent delays in responding to individual search requests during the update. While some index updates are optimized for a particular use, a general index service for many different indices of many different service provides is not free to optimize the index for one type of data holding over another.

### SOME EXAMPLE EMBODIMENTS

Therefore, there is a need for an approach for enhanced updating of a partitioned index, which does not suffer all the disadvantages of prior art approaches.

According to one embodiment, a method comprises receiving first data that indicates a plurality of fields for each entry in an index for a data store. The method also comprises determining initial partitions for the index. The method further comprises receiving second data that indicates at least one value for at least one field of at least a first entry in the index. The method still further comprises automatically determining next partitions for the index based on the second data.

According to another embodiment, a method comprises facilitating a processing of and/or processing: (1) data and/or (2) information and/or (3) at least one signal; the (1) data and/or (2) information and/or (3) at least one signal based at least in part on first data that indicates a plurality of fields for each entry in an index for a data store. The (1) data and/or (2) information and/or (3) at least one signal is further based at least in part on a local and/or remote determining current partitions for the index. The (1) data and/or (2) information and/or (3) at least one signal is further based at least in part on second data that indicates at least one value for at least one field of at least a first entry in the index. The (1) data and/or (2) information and/or (3) at least one signal is further based at least in part on a local and/or remote automatically determining next partitions for the index based on the second data.

According to another embodiment, a method comprises facilitating access to at least one interface configured to allow access to at least one service. The at least one service is configured to perform at least receiving first data that indicates a plurality of fields for each entry in an index for a data store. The service is also configured to determine an initial number of partitions for the index. The service is also configured to receive second data that indicates at least one value for at least one field of at least a first entry in the index. The service is also configured to determine automatically a next number of partitions for the index based on the second data.

According to another embodiment, an apparatus comprises at least one processor, and at least one memory including computer program code, the at least one memory and the computer program code configured to, with the at least one processor, cause, at least in part, the apparatus to perform one or more steps of at least one of the above methods.

According to another embodiment, a computer-readable storage medium carries one or more sequences of one or more instructions which, when executed by one or more processors, cause, at least in part, an apparatus to perform one or more steps of at least one of the above methods.

According to another embodiment, an apparatus comprises means for performing the steps of one of the above methods.

According to another embodiment, a computer program product includes one or more sequences of one or more instructions which, when executed by one or more processors, cause an apparatus to at least perform the steps of one of the above methods.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1A is a diagram of a system capable of enhanced updating of a partitioned index, according to one embodiment;

FIG. 1B is a diagram of the components of a partitioned index service, according to one embodiment;

FIG. 1C is a diagram of further components of a partitioned index service, according to one embodiment;

FIG. 2A is a diagram of an index definition data structure, according to an embodiment;

FIG. 2B is a diagram of an index partition build data structure, according to an embodiment;

FIG. 2C is a diagram of an index partition data structure, according to an embodiment;

FIG. 2D is a diagram of a search request message, according to an embodiment;

FIG. 2E is a diagram of a request statistics data structure, according to an embodiment;

FIG. 3A is a flowchart of a process for enhanced updating of a partitioned index, according to one embodiment;

FIG. 3B is a flowchart of a process for a step of the process of FIG. 3A, according to one embodiment;

FIG. 4 is a flowchart of a process for enhanced search while updating a partitioned index, according to one embodiment;

FIG. 5 is a diagram of hardware that can be used to implement an embodiment of the invention;

FIG. 6 is a diagram of a chip set that can be used to implement an embodiment of the invention; and

FIG. 7 is a diagram of a mobile terminal (e.g., handset) that can be used to implement an embodiment of the invention.

### DESCRIPTION OF SOME EMBODIMENTS

Examples of a method, apparatus, and computer program are disclosed for updating a partitioned index. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term partition refers to a data structure holding a portion of a larger data set. The data set may hold any kind of data, from subscriber data to contents of a music store, book store, video store, art store, game store or any other source of digital content on a communications network. The term index refers to a data structure with at least one field that can be searched. In some embodiments, the entire contents of a store are not arranged in an index, but a subset of the information is placed into a much smaller index that is more efficient to search. For example, a book store could make every page of every book searchable and therefore an index as defined herein. However, it is often more efficient to pull just some fields that are searchable into an index. For example, a few fields that indicate the title, author, publication date, copyright date, ISBN number, a review and a rating are sufficient for a searcher to determine whether a book should be ordered, and every page of the book need not be included as a field of the index. Although various embodiments are described with respect to a partitioned index that points to physical or digital books that can be ordered from a bookstore, it is contemplated that the approach described herein may be used with one or more other indices for other digital content or physical objects. Embodiments are also described as if the users of the index are network services; however, in other embodiments, one or more users are individuals or subscribers of such network services who utilize wireless or mobile user equipment.

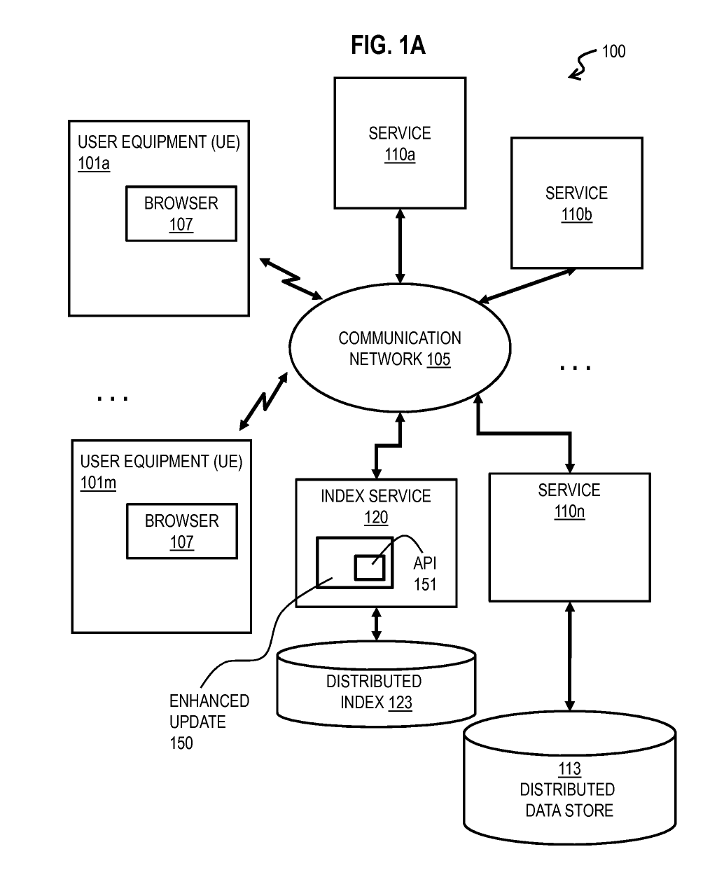

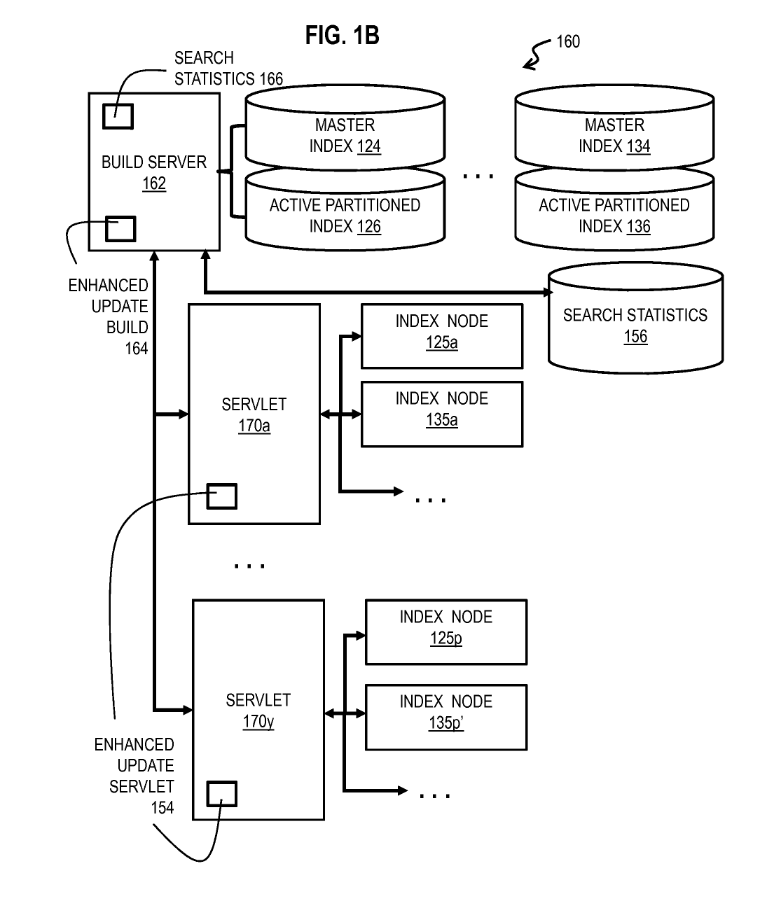

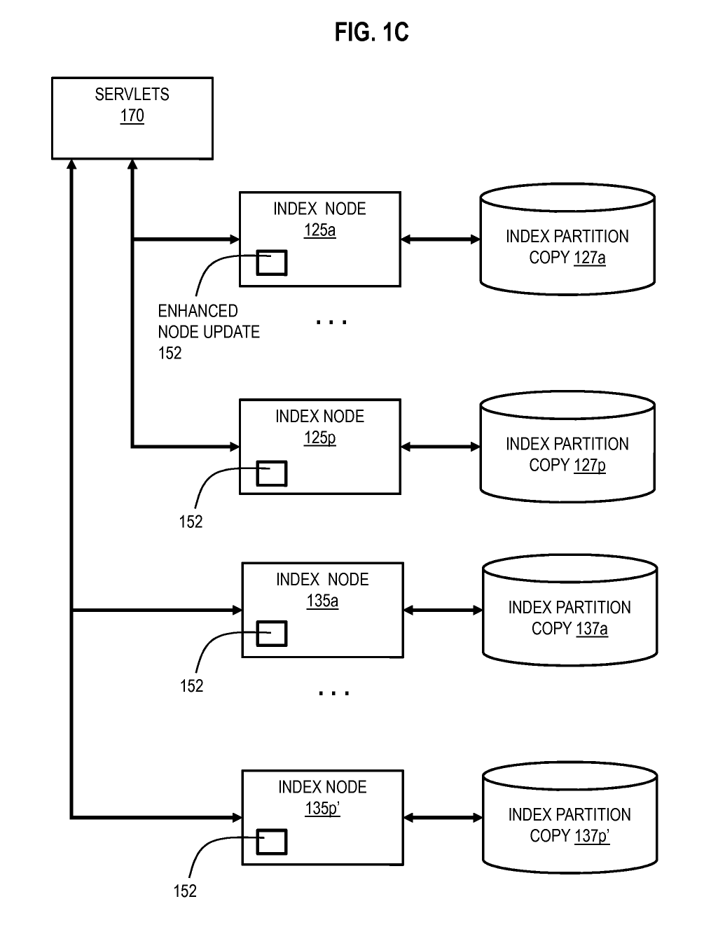

FIG. 1A is a diagram of a system capable of enhanced updating of a partitioned index, according to one embodiment. Users of user equipment (UE) 101a through UE 101m (collectively referenced hereinafter as UE 101) access any of network services 110a, 110b through 110n (collectively referenced hereinafter as network services 110). The network services 110 acquire and store large amounts of information in one or more data storage media called data stores hereinafter. For example, service 110n maintains distributed data store 113. Because such data stores can become very large, with terabytes of data (1 terabyte, TB, =10¹² bytes, where one byte=8 binary digits called bits), it becomes inefficient to search through all this data to find a particular entry. As a consequence, a considerably smaller index of important fields for searching is formed and managed by an index service 120. However, even the index of a few important fields per entry can includes billions of entries. To distribute the computational load of maintaining and searching the index, the index is partitioned; and each partition is placed on a different node of a distributed index 123 that includes multiple nodes. For example, for an index holding two billion (2×10⁹) entries, each of 200 nodes handles a partition of on average 10 million index entries. When a request to search the index is received, each node of the distributed index searches its own partition for index entries that satisfy the search criteria; and the results are aggregated by the index service 120.

In many applications, the distributed data store 113 is not static, but grows (or shrinks) as subscribers join or leave or the inventory of the service 110 increases (or decreases). While an index for a particular purpose can make some simplifying assumption about the stability or growth or shrinkage of their data store and associated index, and relatively stable partitions for the index, the index service 120 set up to support multiple services 110 cannot make the same assumptions. The index service 120 can prompt the providers of services 110 for the expected stability or rate of change of the index, but that is a burden on the user and is not likely to be highly accurate. An index that has too many partitions involves communications among many nodes and can be wasteful of network bandwidth and introduce transmission delays. An index that has too few partitions overwhelms an individual node with too many entries which causes responses to search requests to be inefficient, slow and error prone and the index service 120 to appear unresponsive or even crash.

Furthermore, as updates are made to the distributed data store 113, the distributed index must also be updated in one or more partitions. Because the index is large, the one or more partitions being updated may be offline for a time. During this time, searches are not handled, and, again, this causes the index service 120 to appear unresponsive or to return only partial results.

To address this problem, a system 100 of FIG. 1A introduces the capability to enhance processing of updates for one or more partitioned indices. According to various embodiments, the index service 120 includes an enhanced update module 150. The enhanced update module 150 determines automatically whether to change the distribution of entries among partitions or to change the number of partitions. In some embodiments, the enhanced update module 150 supports searches of the index even if its partitions are being rebalanced. By way of example, rebalancing refers to changes to the system 100 that cause the number of partitions to change or data to move between partitions.

As shown in FIG. 1A, the system 100 comprises user equipment (UE) 101 having connectivity to network services 110 via a communication network 105. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, Personal Digital Assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

At least one network service 110 has access to an index service 120 to build and maintain a partitioned index for that service. In some embodiments, each network service 110 has its own index service 120. In some embodiments, a standalone index service 120 offers indexing services for multiple other network service 110. The index service 120 receives each index entry from a network service 110, in an original load or in one or more updates, and sends it to one partition of the distributed index 123 for storage. The index service 120 also receives each search request from a network service 110 and selects at least one node of the distributed index 123 to process the search request. The node selected is varied for different updates and requests to distribute the load of processing requests.

The index service 120 includes an enhanced update module 150, which automatically partitions the index, automatically revises the partitions as desirable, and supports searches during re-partitioning. The enhanced update module 150 includes an application programming interface (API) 151. The API 151 is a process that accepts input parameter names and values used during the operation of the enhanced update module 150 and returns output parameter names and values. The meaning of the parameters names and valid ranges of values are published and made available to the providers of service 110 or users of UE 101, or both. Those services configure their services 110 to access the functionality of the index service by sending to the API 151 a message that indicates names and values for one or more of the input parameters. The result of the process, such as a search result, is sent in a message that indicates names and values for one or more output parameters from the API 151 to the service 110. In some embodiments the enhanced update API 152 includes one or more separate API, e.g., one API for index definition, a different API for bulk load of the index, yet another API for index updates, and still another API for searches of the index. In some embodiments, one or more of these API are merged.

By way of example, the UE 101 and network services 110 and index service 120 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 5) header, and various application headers (layer 6, layer 7 and layer 7) as defined by the OSI Reference Model.

Processes executing on various devices, often communicate using the client-server model of network communications, widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host on which the process operates. Similarly, the term “client” is conventionally used to refer to the process that makes the request, or the host on which the process operates. As used herein, the terms “client” and “server” refer to the processes, rather than the hosts, unless otherwise clear from the context. In addition, the process performed by a server can be broken up to run as multiple processes on multiple hosts (sometimes called tiers) for reasons that include reliability, scalability, and redundancy, among others. The index service 120 is such a server communicating with the services 110 as clients via a suite of protocols that include the rules of the API 151. A well known client process available on most devices (called nodes) connected to a communications network is a World Wide Web client (called a “web browser,” or simply “browser”) that interacts through messages formatted according to the hypertext transfer protocol (HTTP) with any of a large number of servers called World Wide Web (WWW) servers that provide web pages.

In the illustrated embodiment, each UE 101 includes a browser 107 to communicate with a WWW server included within each network service 110. In some embodiments, a separate service client (not shown) for one or more of the network services 110 is included on one or more UE 101. In some embodiments, the API is a world wide web server for exchanging information between the browser 107 and the enhanced update module 150.

FIG. 1B is a diagram of the components of a partitioned index service 160, according to one embodiment. Thus service 160 is a particular embodiment of service 120 and distributed index 123. The components include a build server 162 and multiple instances of a sub-service called a servlet, including servlet 170a through 170y (collectively referenced hereinafter as servlets 170). It is contemplated that the functions of these components may be combined in one or more components or performed by other components of equivalent functionality on the nodes depicted or different nodes.

The build server 162 includes an enhanced update build module 164. Each servlet 170 directs one or more index nodes for corresponding partitions of a corresponding index, such as index nodes 125a through 125p for the p partitions of one index, and index nodes 135a through 135p′ for the p′ partitions of a different index (collectively referenced hereinafter as index nodes 125). In some embodiments, each servlet 170 controls one partition each of multiple different indices. In some embodiments, a servlet controls multiple partitions of a single index in addition to, or instead of, one or more partitions of corresponding different indices. In the illustrated embodiment, each servlet 170 includes an enhanced update servlet module 154. Using multiple servlets is an example means of achieving the advantage of distributing the computational load of forming and searching partitioned indices.

The build server 162 maintains a master index for each different index, such as master index 124 through master index 134 (collectively referenced hereinafter as master index 124). In some embodiments, the master index 124 resides on a shared, redundant and highly available file system. The build server also derives an active partitioned index from each master index, such as active partitioned index 126 and active partitioned index 136 (collectively referenced hereinafter as active partitioned index 126) derived from master index 124 (excluding 134) and master index 134, respectively. All data for an index is updated to the master index 124, which is an example means of obtaining the advantage of a providing a single authoritative version of the index. In some embodiments, the master index is not partitioned. The enhanced update build module 164 determines automatically how to partition the index. In some embodiments, the build server 162 includes a search statistics module 166 that maintains a search statistics data structure 156; and the automatic determination of a number of partitions is based on search performance statistics derived from the search statistics data structure 156

For example, in some embodiments, an index includes one or more key fields. A hash of the key fields produces a random number (called a hash value) substantively evenly distributed in a number range, such that the same values in the key fields always produce the same random number. A range of these hash values are assigned to each partition. As items are added to the index, the build server 162 adds new index entries to the master index and the active partitioned index 126 based on the hashed values for the key fields. The build server 162 then notifies the servers of any updates to existing partitions or re-partitions of the index, and the affected index nodes apply the updates to a local copy, or copy the appropriate partition from the active partitioned index 126. The bulk copy is often faster than doing a large number of inserts and deletions and replacements of the accumulated changes.

As the index grows, more partitions are needed to keep search performance acceptable; and the enhanced update build module 164 automatically determines the number of partitions and then assigns one or more smaller ranges of these hashed values for each new partition. The changed partition definitions are used to generate new versions of the active partitioned index 126. The enhanced update build module 164 of the build server 162 then notifies the servers of any changes to the partitions, and the affected index nodes copy the appropriate partition from the active partitioned index 126. New index nodes 125 at one or more servers take on the responsibility for copying and servicing requests for the new partitions. The active partitioned index 126 thus is an example means to provide the advantage of providing both a backup for the partitions at the index nodes and propagating a change of index entries in a partition to the index nodes.

In various embodiments, the servlets 170 respond to searches of an index by sending the search to one or more index nodes 125, which satisfy the search based on the data in their copy of their partition of the index. In this way, searches can be supported at an index node 125 even while the master index 124 is being updated with new or deleted entries or the active partitioned index 126 is being re-partitioned by the enhanced update build module 164, or some combination.

FIG. 1C is a diagram of the components of index service distributed indices 160, according to one embodiment. By way of example, the distributed index 123 includes two or more index nodes 125, each with one or more components comprising an enhanced node update module 152. One or more of these components provide enhanced updating of a partitioned index. It is contemplated that the functions of these components may be combined in one or more components or performed by other components of equivalent functionality on the nodes depicted, or on different nodes.

In the illustrated embodiment, the distributed index 123 includes index node 125 for a first index, and includes index nodes 135 for a second index, where p indicates the number of partitions in the first index and p′ indicates the number of partitions in the second index. In other embodiments, distributed index 123 includes index nodes for more or fewer indices. Each index node 125, 135 maintains and searches the index entries in at least one index partition for at least one index. In the illustrated embodiment, index nodes 125a through index node 125p operate on the index entries in index partition 127a through 127p, respectively. Similarly, index nodes 135a through index node 135p′ operate on the index entries in index partition 137a through 137p′, respectively. Index nodes 127a through 127p and index nodes 135a through 135p′ are collectively called index partition copies 127 hereinafter.

When a search request is received at the index service for searching one of the indices, the request is directed to one of the index nodes for the requested index, e.g., through the servlets 170. The index node that receives the request is called an aggregator node and is responsible for substantively satisfying the request with index entries from any of the partition copies 127. The index service 120 distributes multiple requests across the different index nodes, e.g., via different servlets 170, so that each functions as the aggregator node for at least some requests. This distributes the load of responding to search requests. The aggregator node determines what index entries to request from the other index nodes for the index, if any. The aggregator receives the matching index entries (called matches herein) from the other index nodes, if any, and combines the matches into one response that is sent to the requesting network service 110 via the index service process 120.

According to various embodiments, each index node 125, 135 includes an enhanced node update module 152 for processing such search requests while an index is being updated, as well as to update a partition copy based on notices from the build server 162, as described in more detail below.

Although processes and data structures are shown in FIG. 1A and FIG. 1B and FIG. 1C as integral blocks in a particular order on particular nodes of the communication network for purposes of illustration, in other embodiments, one or more processes or data structure or portions thereof are arranged in a different order on the same, more or fewer nodes of the network or in one or more databases or are omitted or one or more additional processes or data structures are included.

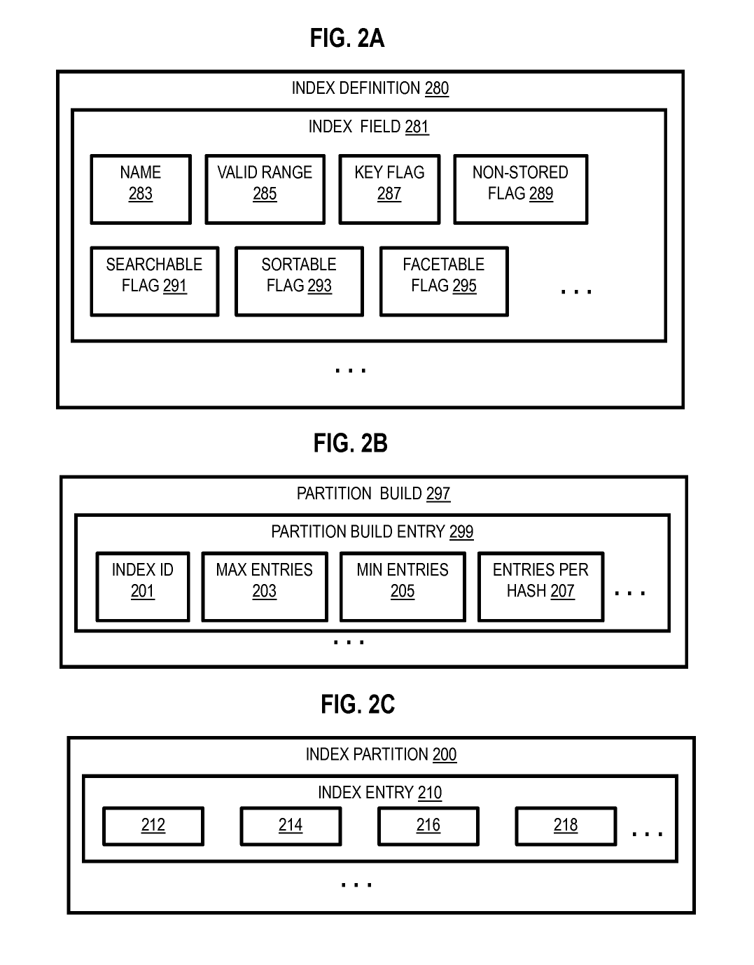

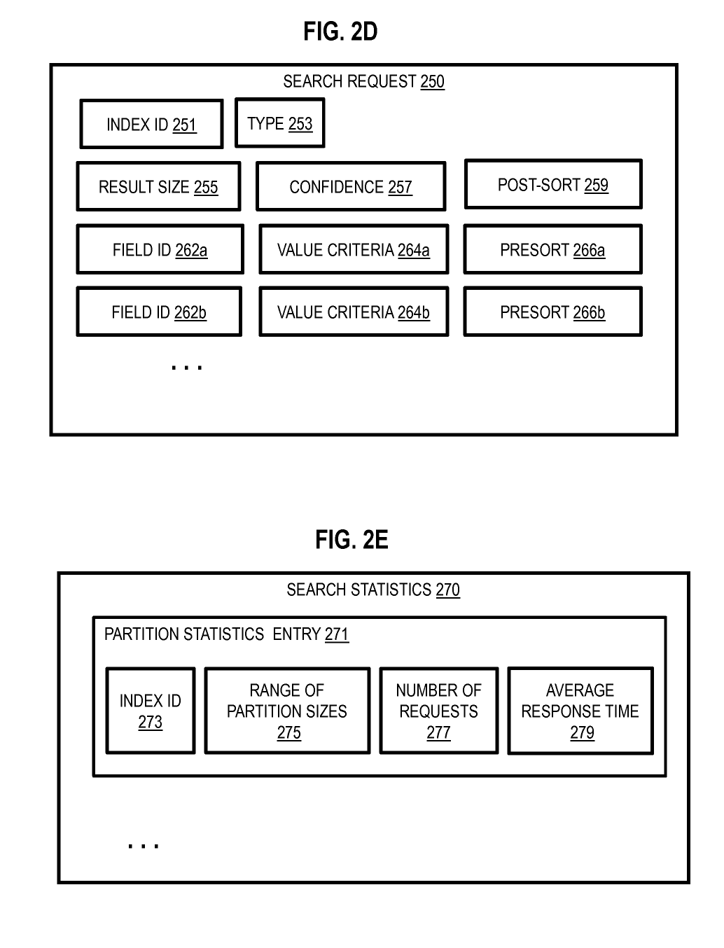

FIG. 2A is a diagram of an index definition data structure 280, according to an embodiment. For example, fields for the index definition data structure are provided by a service 110 as an extensible markup language (XML) document through API 151 of the index service 120 and stored by the build server 162 in data structure 280. The index definition data structure 280 stores metadata about the index fields in each index. Other indices, e.g., used by other service 110, are stored in other instances of the index definition data structure 280. For each field in an index, the index definition data structure 280 includes an index field entry 281. Other index field entries are indicated by ellipsis. Although fields, entries, messages and data structures are depicted in FIG. 2A through FIG. 2E as integral blocks in a particular arrangement for purposes of illustration, in other embodiments, one or more fields, entries, messages, data structures, or portions thereof, are arranged in a different order or in one or more messages or one or more databases on one or more nodes of the communications network, or are omitted, or one or more additional fields, entries or data structures are included.

The index field entry 281 includes a name field 283, a valid range field 285, a key flag field 287, a non-stored flag field 289, a searchable flag field 291, a sortable flag field 293, a facetable flag field 295, and zero or more other fields indicated by ellipsis. In other embodiments, fewer or different or more fields are included.

The name field holds data that indicates a unique identifier, within the index, for the index field. The unique identifier is used, in some embodiments, when values are provided for the index and the values are to be associated with a particular field indicated by the identifier. The name field is chosen to be unique among all the index fields in a single index. In some embodiments, values are given in the same order as fields are described in the index definition data structure, and the name field 283 is omitted.

The valid range field 285 holds data that indicates a valid range for values to be associated with the index field in the index. For example, the valid range indicates four digit number fields between 1900 and the present year for a copyright date in an index of books available from an online bookstore.

The key flag field 287 holds data that indicates whether the index field is used as a key for finding the entry or for hashing to determine a partition for storing the index entry, or both. For example, in some embodiments, the key flag field is a single bit for which one value (e.g., 0) indicates the field is not a key field and a different value (e.g., 1) indicates the field is a key field. In some embodiments, the key flag field is a logical byte for which one value (e.g., FALSE) indicates the field is not a key field and a different value (e.g., TRUE) indicates the field is key field. One or more different fields in an index may be indicated as keys.

The non-stored flag field 289 holds data that indicates the index field is not frequently searched or sorted (such a text of a book review). An index field that is not frequently searched or sorted, need not be updated and need not be stored in the partitioned index but can be retrieved as needed from the master index. If the contents are small enough, the value is efficiently stored in the index copies, but longer items, such as a book review, are best stored in the master index but not the copies. In various embodiments, the non-stored flag field holds a single bit or a logical byte.

The searchable flag field 291 holds data that indicates whether the index field is searched. Index fields that are searched are used to derive a search index in which searched values are listed and for each search value a list of index entries that satisfy the search value are provided. In various embodiments, the searchable flag field holds a single bit or a logical byte.

The sortable flag field 293 holds data that indicates whether the index field is ever going to be sorted. In one embodiment, these flags allow search requests to sort their results sets against this field. In various embodiments, the sortable flag field holds a single bit or a logical byte.

The facetable flag field 295 holds data that indicates an index field for which search results are given as a count in addition to the search values. This is common for index fields with very few different values, such as the name of publishing houses. A search for all books published on the Civil war can be faceted on the publishing house, with results such as “2,000 books on the Civil War including 500 by Publisher A, 600 by Publisher B, and 900 by Publisher C.” In various embodiments, the facetable flag field holds a single bit or a logical byte.

FIG. 2B is a diagram of an index partition build data structure 297, according to an embodiment. The build server 162 keeps track of the partition boundary definitions, e.g., the sets of hashed values that define each partition, based on the partition build data structure 297. For example, the index partition build data structure 297 is stored by the build server 162, e.g., in the search statistics data structure 156. The partition build data structure 297 holds a partition build entry field 299 for each index maintained by the index service 120. Partition build entry fields 299 for other indices are indicated by ellipsis. Each partition build entry field 299 in the illustrated embodiment includes an index identifier (ID) field 201, a maximum entries field 203, a minimum entries field 205, an entry per hash field 207, among zero or more other fields indicated by ellipsis.

The index ID field 201 holds data that uniquely identifies the index among all the indices maintained by the index service 120. In some embodiments, this ID is based on an identifier (such as the universal resource locator, URL) of the service 110 that provides the index entries. In some embodiments, this value is based on a name provided by a user, such as the service 110, through the API 151. In some embodiments, this value is generated sequentially by the index service 120 as each new index is formed.

The maximum entries field 203 holds data that indicates the maximum number of index entries per partition that is considered to have acceptable search performance. Any method may be used to determine this value. In some embodiments, as described in more detail below, this value is based on observed search performance for partitions of different sizes for this particular index. As the number of entries in one partition reaches or exceeds this maximum, the enhanced update build module 164 of build server 162 automatically considers re-partitioning the index, e.g., carving out one or more subsets of hash ranges for defining additional partitions.

The minimum entries field 205 holds data that indicates the minimum number of index entries per partition that is considered to justify keeping the index entries separate from another partition. Any method may be used to determine this value. In some embodiments, as described in more detail below, this value is based on observed search performance for partitions of different sizes for this particular index. As the number of entries in one partition falls below this minimum, the enhanced update build module 164 of build server 162 automatically considers re-partitioning the index, e.g., merging one or more hash ranges for defining a new set of partitions with a reduced number of partitions.

The entries per hash field 207 holds data that indicates the current number of entries per hash value. Any method may be used to express this value. For example, in some embodiments, the hash ranges currently defining all partitions are listed along with the number of entries per partition. In some embodiments, the total number of entries is divided by the total number of unique hash values, to determine an average number of entries per hash value in order to determine an average hash range to obtain a desired average number of entries per partition.

FIG. 2C is a diagram of an index partition data structure 200, according to an embodiment. The index partition data structure 200 is a particular embodiment of one of the index partitions 127 or 137 of one index. The index partition data structure 200 includes multiple index entries as indicated by index entry 210 and ellipsis. Each index entry 210 includes one or more fields, such as fields 212, 214, 216, 218 and others indicated by ellipsis, collectively referenced as index fields 212. Each field holds data that indicates a value for a corresponding parameter. One or more of the fields 212 are searchable by the network service 110 for which the index is maintained. In one embodiment, the index may have only one field that is searchable. For example, indices that have no keys (non-keyed indices) can internally assign a key for internal tracking purposes but the internal keys are not visible to a customer. So, the index defined by the customer may have one or more fields. For keyed indices, there may be at least one field in addition to the key field.

For example, in a book index, several fields hold text or numbers that represent values for corresponding parameters that include title, author, International Standard Book Number (ISBN), publication date, copyright date, review and rating, among others, in any combination of one or more parameters. Similarly, in a game index, several fields hold text or numbers that represents values for the parameters that include name, game type, vendor, platform on which the game operates and rating, among others, in any combination of one or more.

FIG. 2D is a diagram of a search request message 250, according to an embodiment. A search request message 250 is sent from a user, such as network service 110, to the index service 120 to search a particular one of the indices based on some interaction with a UE 101 of a particular user. The index service 120 forwards the request to one of the index nodes of the particular index via a servlet 170 based on a load balancing scheme. That index node functions as the aggregator node. If the aggregator node determines that another index node of the same particular index is also to be involved, then a search request 250 is sent from the aggregator index node to one or more other index nodes for the particular index.

In the illustrated embodiment, the search request message 250 includes two or more of an index ID field 251, a type field 253, a result size field 255, a confidence level field 257 and a post-sort field 259 and one or more search criteria. Each search criterion is indicated by a set of fields, such as an index field identifier (ID) field 262a, a value criteria field 264a and a presort condition field 266a. A second criterion is indicated by fields 262b, 264b and 266b. Subsequent criteria, if any, are represented by ellipsis.

The index ID field 251 holds data that indicates which of two or more indices managed by the index service 120 is to be searched. In some embodiments in which the index service 120 maintains only one index, field 251 is omitted. An advantage of specifying the index ID is that one index service 120 can manage multiple indices. The index ID field 251 is an example means to achieve this advantage. In one embodiment, the index ID field 251 could also represent a view, which may be constructed from several indices.

The type field 253 holds data that indicates whether the request message 250 is from a network service 110, or from the index service 120 to the aggregator node, or from the aggregator node to another index node of the same index. An advantage of specifying the type is that an index node that is responding to a request from an aggregator index simply examines its own index partition and does not need to consume computational resources to determine and request contributions from other index nodes. The type field 253 is an example means to achieve this advantage. In some embodiments, there are two distinct interfaces (such as APIs) to each index node 125. One interface is invoked by the client on the aggregator node and the other interface is invoked by the aggregator node on another index node. In such embodiments, neither the aggregator nor the other index node needs to use any IDs to know where the call is coming from and what the response to the call is. In such embodiments, the type field 253 is omitted.

The result size field 255 holds data that indicates a target number T of index entries to return, which match all the search criteria, i.e., a target number T of matches to return. In some embodiments, the target number of matches is determined independently of the request message, e.g., as a default quantity or by a calculation of the amount of computational power to be consumed in matching the criteria, and field 255 is omitted. An advantage of specifying the target number T is that computational and bandwidth resources are not wasted aggregating and returning an excessive number of matches that neither the network service 110 nor the user of UE 101 desires to parse. The result size field 255 is an example means to achieve this advantage.

The confidence level field 257 holds data that indicates a confidence level for obtaining the single set of matches for a deterministic request. In some embodiments, the confidence level is determined independently of the request message, e.g., as a default quantity or by a calculation of the cost benefit of deviating from 100% confidence, and field 255 is omitted. An advantage of specifying the confidence level is that computational and bandwidth resources are not consumed aggregating and returning matches that are unlikely to contribute to the single set of matches. The confidence level field 257 is an example means to achieve this advantage.

The post sort field 259 holds data that indicates how to sort the index entry matches in a response that includes multiple such matches. For example, the post-sort field 259 holds data that indicates the index fields and ascending or descending orders for sorting the matches.

The index field ID fields 262a, 262b, among others indicated by ellipsis (collectively referenced as index field ID field 262) hold data that indicates one of the fields 212 in an index entry 210. Any method may be used to indicate the index field, e.g., by its ordinal number in the index entry or by its parameter name. For example, the title field in a book index is indicated by the text “Title” or the ordinal number “1.”

The value criteria fields 264a, 264b, among others indicated by ellipsis (collectively referenced as value criteria field 264) hold data that indicates one or more values or value ranges to be satisfied by matching index entries. For example, the value criteria field holds data that indicates “includes ‘Civil War’” or “excludes ‘computer’” or “starts with letters ‘Ca’ through ‘Ebo’.” If all values are acceptable, e.g., the field is used only for sorting, then the value criteria includes data that indicates “null” or equivalent or the field is omitted.

The presort fields 266a, 266b among others indicated by ellipsis (collectively referenced as value criteria field 266) hold data that indicates one or more sort criteria for a sort to be performed before a final match set is determined. If there is not a presort criteria, e.g., the index field indicated in field 262 is used only for selection, then the presort field includes data that indicates “None” or equivalent, or the field is omitted. For example, to include the oldest publication dates, the presort field 266 for the publication date field holds data that indicates “oldest” or equivalent. For example, to include the highest rated books, the presort field 266 for the rating field holds data that indicates “highest” or equivalent. Typically, an entry other than “none” or equivalent in any presort field 266 renders the search request of the message 250 deterministic.

FIG. 2E is a diagram of a search statistics data structure 270, according to an embodiment. The search statistics data structure 270 is a particular embodiment of search statistics data structure 156. The search statistics stored in data structure 270 are used in some embodiments to estimate the maximum number of index entries to include in a single partition. In the illustrated embodiment, the search statistics data structure includes a partition statistics entry 271 for each index. The partition statistics entries 271 for other indices or partition sizes are indicated by ellipsis. In the illustrated embodiment, each partition statistics entry 271 includes an index identifier (ID) field 273, a range of partition sizes field 275, a number of requests field 277, and an average response time field 279.

The index ID field 273 holds data that uniquely identifies the index among multiple indices maintained by the index service 120. The range of partition sizes field 275 holds data that indicates a range of partition sizes for which statistics are combined. For example, the statistics are accumulated for partition sizes less than 1 million entries, for 1 million to 5 million entries, from 5 million to 25 million entries, from 25 million to 100 million entries, from 100 million to 200 million entries, from 200 million to 300 million entries, etc.

The number of requests field 277 holds data that indicates how many requests were received that involved searches of partitions of the size indicated in field 275. The advantage of this field is to indicate the statistical significance of the data and allow new data to be incorporated into the average. The average response time field 279 holds data that indicates the average time to respond to a request for the number of requests indicated in field 277 in the partition size range indicated in field 275. In other embodiments, more or fewer or different statistics are included in each partition statistics entry field 271.

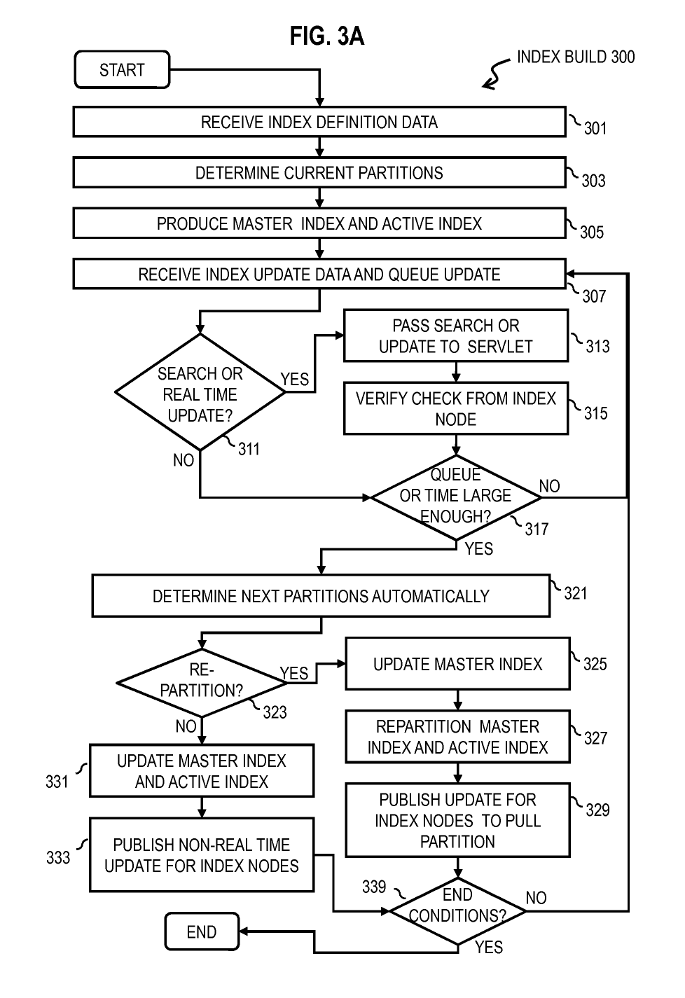

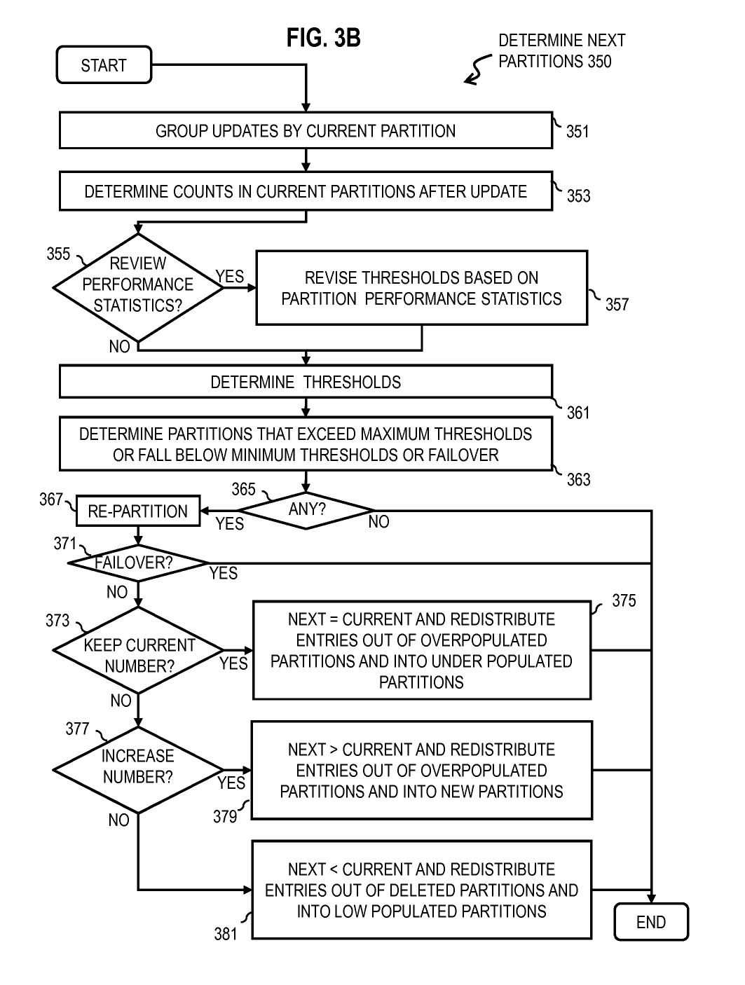

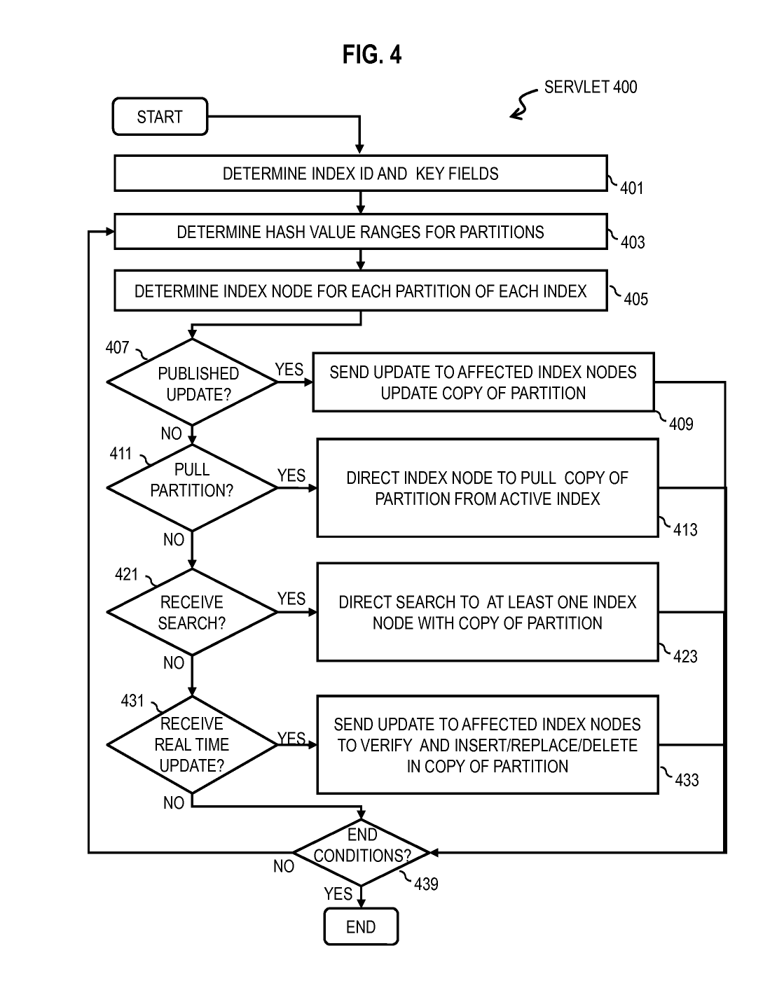

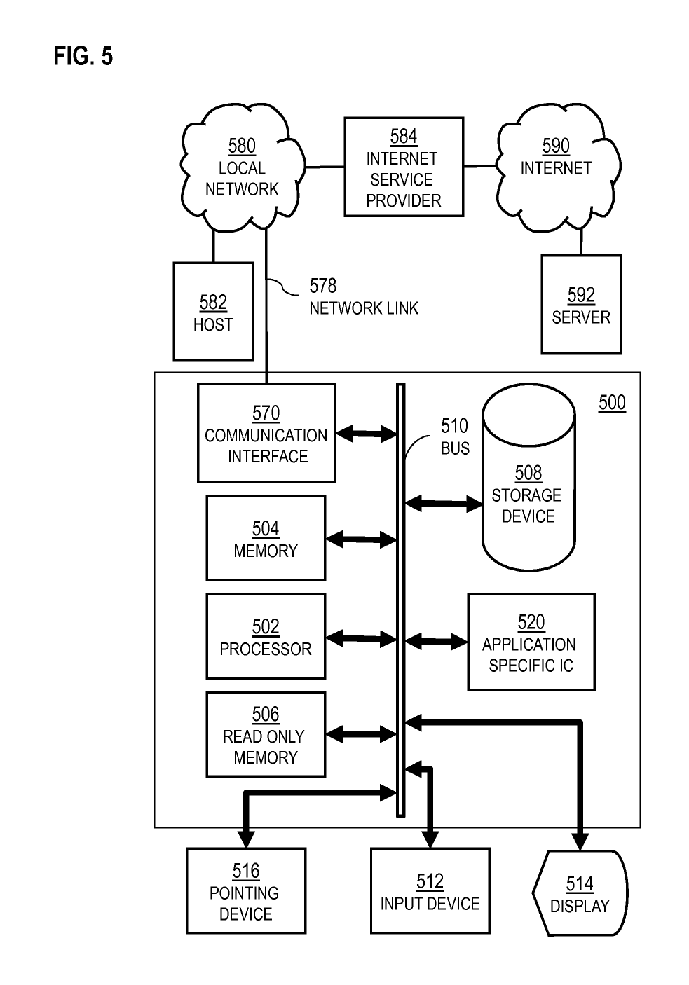

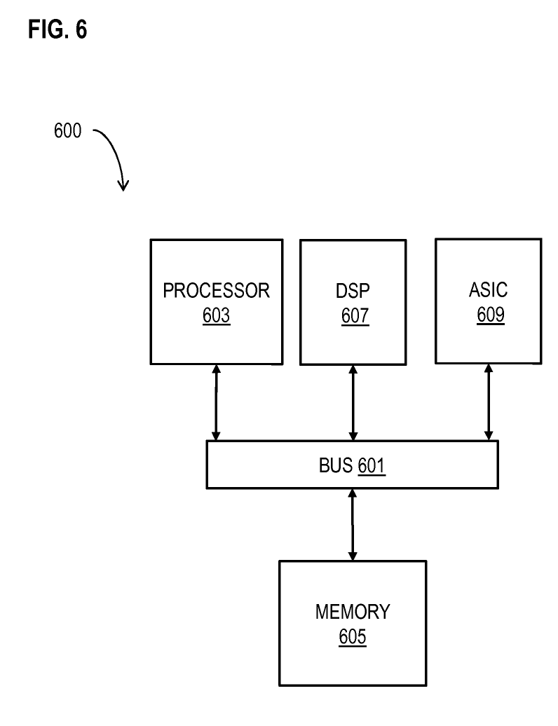

FIG. 3A is a flowchart of a process 300 for enhanced updating of a partitioned index, according to one embodiment. In one embodiment, the enhanced update build module 164 performs the process 300 and is implemented in, for instance, a chip set including a processor and a memory as shown in FIG. 6 or general purpose computer as presented in FIG. 5. Although steps are shown as integral blocks in a particular order in FIG. 3A, and subsequent flowcharts in FIG. 3B and FIG. 4, in other embodiments, one or more steps or portions thereof are performed in a different order, or overlapping in time, in series or in parallel, or are omitted, or one or more other steps are added, or the process is changed in a combination of ways.

In step 301, index definition data is received and stored in index definition data structure 280, as depicted in FIG. 2A. For example, a service 110 sends one or more messages to the index service API that indicate the index field entries 281 for each field in the index. In some embodiments, the index fields entries 281 are formatted as an XML document. This data indicates each field in the index, a valid range therefore, which fields serve as a key on which to organize the index, which are searchable, sortable, facetable or stored only in a master and not in copies, or some combination. It is desirable that the combination of values in the one or more key fields uniquely identify a single index entry. Thus in the book index example embodiment, the author field and date field are usefully indicated as key fields. Therefore, step 301 includes receiving first data that indicates a plurality of fields for each entry in an index for a data store.

In some embodiments, the index definition data also indicates the number of index entries in the initial load and the number of index entries expected at maturity for the index. In some embodiments, an initial number of partitions is also specified in the index definition data received during step 301.

In some embodiments, the index definition data is received with an initial load of values for one or more entries. This initial load, and subsequent updates are treated as described below.

In step 303, the current number of partitions is determined automatically. For example, a minimum number of partitions, such as 3, is determined for the current number in order to set up the mechanism to grow the number of partitions. In other embodiments another minimum number is determined, such as one (1) or two (2) partitions. In some embodiments, the minimum number of partitions is determined based on the number of fields in the index. An index with a lot of fields is expected to tax an index node responsible for it, so the number of entries per partition is kept small and the number of partitions, including the initial current number of partitions is made larger. Conversely, an index with few fields is expected not to tax an index node responsible for it, so the number of entries per partition is kept large and the number of partitions, including the initial current number of partitions is made smaller. In some embodiments, the total size of entries is another factor. For example, an index with a few very large fields might be more taxing than an index with many more small fields. Based on the number of partitions, the hashed value range is divided up among the current number of partitions. In some embodiments that provide the initial number of partitions during step 301, step 303 includes determining the initial number of partitions based on the value provided during step 301.

In some embodiments that provide estimates of the number of entries during step 301, step 303 includes determining the initial number of partitions based on the estimated number of entries. For example, each index node is designed to perform well with an index partition up to a maximum number of bytes, called the design maximum, hereinafter. The number of bytes per index entry is estimated from the index fields in the definition data, and the maximum number of entries is determined based on dividing the design maximum by the estimated bytes per index entry. The partition is started with a fraction of this maximum number of entries, such as 10%. Thus the number of entries per partition initially is 10% of the estimated maximum number of entries per partition. The initial number of partitions is then determined to be number of entries provided during step 301 divided by 10% of the maximum number of entries estimated per partition.

In some embodiments, the hashed values are divided approximately evenly among the number of partitions. For example, a hashed value range of 1001 values (from 0 to 1000) is divided approximately evenly among the initial three partitions, so hashed values from 0 to 333 are associated with the first partition, hashed values from 334 to 667 are associated with the second partition, and hashed values from 668 to 1000 are associated with the third partition. In some embodiments the hashed value range is divided unevenly.

In general, step 303 includes determining current partitions for the index.

In step 305, a master index 124 and active index 126 are generated. At first there are no entries in these indices. The master index has the authoritative version of the index. Entries are added to the master index in order received and checked for validity and reasonableness, e.g., using the valid range field for each index field. Add, delete and replace updates are accommodated at the master index. In some embodiments, the master index is sorted on the key values; and, in some embodiments, the master index is partitioned. In some embodiments, the master index is not sorted or partitioned. The active partitioned index 126 (called the active index 126 hereinafter) is derived from the master index. The active index 126 is formed during step 305 with the initial number of partitions.

In step 307, an index update is received with values for one or more index entries to add, or values to replace existing index entries, or with an indication of which index entries to delete, or some combination. The index update is formatted as a series of one or more index entries, such as index entry 210, with another field indicating an operation, such as insert, delete, replace. In some embodiments, the operation is implied based on the index entry field 210. Insertions, deletions and replacements are based on the values in the key fields. If the values in the key fields match an existing entry, then those values replace the values already in that entry. The entry to be deleted is indicated by the values for the key fields. In cases where other fields exist, the system 100 may ignore their values and/or apply null values to the other fields. An entry with a new combination of values in the key fields is inserted as a new entry in the index. If an initial load of one or more entries are provided, those entries are considered insertion updates for purposes of step 307. Thus, step 307 includes receiving second data that indicates at least one value for at least one field of at least a first entry in the index.

The insertion entries of the initial load are added to the master index, in the order provided. The key values in the master index are then hashed to determine which of the initial partitions each entry belongs to, and the entry is added to that partition of the active index 126. Index fields flagged to indicate non-stored values are included in the master index 124 but not in the active index 126. In some embodiments, the entries in the active index 126, are sorted by the values in the key fields.

In some embodiments, notification of the availability of the active index and the partition each index node is responsible for, is sent to the index nodes, e.g., through the servlets 170. This process is called publishing the index update. In response, each index node 125 copies the appropriate partition from the active index 126 and stores that copy locally in an index partition copy data structure 127. In other embodiments, the signal for initial pulling of the partitions or publishing of the updates can be communicated directly to the servers, thereby bypassing the servlets 170.

For subsequent updates, the insert, delete, replace entries are placed in a queue for applying to the master docket. Because there are fixed overhead costs for updating an existing index, including changing the master index, propagating the change to the active index, publishing the change to the index nodes, it is wasteful of bandwidth to propagate each update, one entry at a time, and it consumes extra processing power on each affected node. For example, it is assumed for purposes of illustration that there are ten seconds of fixed delay to update the master docket, propagate the change to the active docket, publish the changes to the index nodes, and have the index node insert the changes. By accumulating multiple changes in a queue before starting the update process, the fixed overhead costs are amortized over multiple entries and is more efficient. Thus a queue of index updates is an example means of achieving the advantage of minimizing overhead costs per index entry. The queue comprises a series of index entries 210 (in some embodiments, the queue includes an extra field that indicates the operation, such as insert, delete, replace; the operations may be queued on a partition-by-partition basis).

In some embodiments, the decision on when to process the updates in the queue for the master docket is based on a target turnaround time. For example, if it is desired that indexes be updated within 30 seconds of receiving an index update from a user, and the fixed costs are ten seconds, then accumulating 15 seconds of index updates in the queue before processing the updates provides the target turnaround time more efficiently than processing each update separately, and still leaves 5 seconds (about 16%) leeway for processing updates queues of larger than average number of updates. Thus, a decision on when to process the queue of updates is based, at least in part on the target turnaround time (e.g., 30 seconds). Such delayed updates are called asynchronous updates of the index. Searches performed more than the target turnaround time after an asynchronous index update thus reflect the updated index.

In some embodiments, the index service 120 supports faster turnaround for more limited updates. These accelerated updates are called real time updates (also called synchronous updates) and offer a much faster turnaround time (e.g., 1 second), but are limited to updates of relatively small size, e.g., less than a ceiling number of entries, such as less than 1000 entries. In some embodiments, the synchronous updates are implemented as updates applied first at the index node 125 and later at the master index 124 and active index 126. In some embodiments, the synchronous update is indicated by an additional operation field. In some embodiment, a separate API is provided for synchronous updates; e.g., one API is available for asynchronous index updates, including the initial load, and a different API is available for synchronous index updates of fewer than the ceiling number of entries.

In some embodiments, searches are supported during the index updates, whether synchronous or asynchronous. In the illustrated embodiment, searches and index updates are received at the enhanced update API 151, either at a search API, an asynchronous update API, or a synchronous update API, or some combination. The asynchronous updates are added to the queue. In some embodiments the real time updates are also added to the queue.

In step 311, it is determined whether a search or real time update is received, e.g., at API 151. If so, then in step 313 the search or real-time update is passed to an appropriate index node to handle the search or update, either directly or through a servlet 170. The search is based on one or more of the copies of the partitioned index in one or more data structures 127. Similarly, the real time update is applied to one or more of the copies of the partitioned index in one or more data structures 127 by one or more index nodes. In some embodiments, step 311 and step 313 are performed by the index service 120 outside of the build server 162. Thus, even if the next partitions are different from the current partitions, step 313 includes supporting a search of at least the second entry (in a possibly obsolete partition copy) before at least the second entry is stored into at least the first partition (a possibly new partition). By way of example, when the real-time updates are received in the servlet 170, they are sent back to the build server to be applied to the partitions on the back end (master and active copies on the build server) and also sent to the appropriate data nodes to be applied directly to the local partitions on the data nodes where they are searched. In this case, no search is performed on any obsolete data. Accordingly, in order for the system to apply the updates to local partitions on the data nodes, it only needs to get the updates accepted by the build server and not necessarily applied to the partitions on the back-end.

In some embodiments, the real time update is applied if the update has fewer than a ceiling number of entries, such as 1000 entries, as described above. Thus, in such embodiments, step 311 and 313 includes, if the second data indicates the at least one value for the at least one field of no more than a ceiling number of entries, then before at least the first entry is stored into at least the first partition (e.g., the partition of the active index), storing at least the first entry into the copy of at least the first partition (e.g., the index partition copy 127). As discussed above, in some embodiments, the system need only get the updates accepted by the build server and not necessarily applied to the partitions on the back-end. In some embodiments, the process includes determining the ceiling number of entries based on a time to store at least the ceiling number of entries into the copy of at least the first partition, such that the time is less than a maximum time of about 1 second.

In step 315, a message is received from each index node performing a real time update. The message indicates the update to be implemented at the index node. In step 315, the build server 162 determines whether the update should be applied, e.g., whether the update includes values within the valid range, and notifies the index node of the updates that should be applied. In another embodiment, the build server accepts the updates in their entirety and sends an acceptance message to the servlet 170 without making the determination. The build server also adds the updates to the queue for applying to the master index and propagating to the active index, if not already there from step 307. These updates do not need to be published, as described below with reference to step 333 or 339, to notify the index nodes that have already made the changes. However, in some embodiments, the updates are “officially” implemented at the index nodes by copying the appropriate partition from the active index upon receiving the publish notification, and in these embodiments, the updates are published to the affected index nodes (either directly or through one or more servlets 170).

In step 317, it is determined whether the queue for asynchronous updates is large enough, or the time since the last update to the master index is greater than the difference between the target turnaround time and the fixed cost (with any leeway), or some combination. If not, then control passes back to step 307 to await the next index update and update the queue. If so, e.g., if 15 or 20 seconds of updates have been accumulated, then control passes to step 321. In some embodiments, step 317 includes determining if one of the index nodes, or the copy of the index partition at an index node has failed, then control passes to step 321 under failover conditions.

In step 321, the next partitions are determined automatically. For example, it is determined whether to increase or decrease the number of partitions or leave the number the same. In various embodiments, this determination is made based on index entries in each partition and the thresholds for maximum number of entries per partition, or search statistics, or some combination. Multiple steps that comprise step 321 in some embodiments are described below with reference to FIG. 3B. In some embodiments, the total number of partitions is not changed, but the boundaries between partitions are changed. For example, the hash value border between an overpopulated partition and an under populated partition is moved into the under-populated partition. Increasing or decreasing the number of partitions, or changing the hash value border between partitions is called re-partitioning. Thus step 321 includes automatically determining next partitions for the index based on the second data of at least one value for at least on field for at least one entry.

In some embodiments, step 321 includes determining whether an index node has failed and lost its index partition copy 127. In case a node that is responsible for serving one or more partitions or any index fails, the responsibility of serving those partitions are distributed among the remaining nodes in the system. Once that happens, the nodes copy the new partitions from the backend to their local storage and start serving them.

In step 323, it is determined whether the index is being re-partitioned. In case of failure of an index partition copy that leads to a failover condition where one server has failed and all its responsibilities are transferred over to other servers in the cluster, the server that just became responsible for the new partition will copy the partition from the build server to its own local storage and starts serving it. For example, under this scenario, no reparation occurs and the build server continues maintaining the partitions normally. If not, then in step 331, the updates in the queue are separated by partition. The master index is updated, and the partitions in the active index are updated based on the changes to the master index. In step 333, the changes for each partition are published to the affected index nodes 125 (either directly or through the servlets 170), which make the changes. Thus step 333 includes, after at least the second entry is stored into at least the first partition (existing partition of active index), propagating the change to the copy of at least the second partition (partition copy 127 at the index node of the same partition). Thus step 331 includes automatically determining to store the second data into at least a first partition of the next partitions in the active index. Step 333 includes after at least the first entry is stored into at least the first partition (active index), propagating the change to the copy of at least the first partition (index partition copy 127). In an illustrated embodiment, the updates are propagated to the index party copy within 30 seconds. Thus step 333 includes propagating the change to the copy of at least the first partition within about 30 seconds of receiving the second data.

If it is determined in step 323 that the index is being re-partitioned, then in step 325 the maser index is updated with the updates in the queue. In step 327 the active index is re-formed based on the master index and the new definitions of the partitions. In some embodiments, the master index is also partitioned during step 327. In case of failover, the new server responsible for the new partitions will continue to serve requests. In step 329, the new partitions for each index node are published to the affected index nodes (either directly or through the servlets 170). Those affected index nodes then pull the corresponding partition from the active index. Thus step 329 includes, if at least the second (obsolete) partition is different from at least the first (new) partition, then after at least the second entry is stored into at least the first partition (new partition of active index), propagating the change to the copy of at least the second partition (partition copy 127 at the index node of a possibly obsolete partition). Step 329 also includes determining a different index node to replace a failed index node (either directly or through the servlets 170).

After step 333 or 329, it is determined in step 339 whether end conditions are satisfied, such as withdrawing the index service. If so, the process ends. Otherwise control passes back to step 307 to receive further updates.

Because the copies are available during steps 321 through 333, searches are supported while the partitions are determined and the master index and active index are being updated or re-partitioned or both.

FIG. 3B is a flowchart of a process 350 for a step 321 of the process 300 of FIG. 3A, according to one embodiment. Thus process 350 is a particular embodiment of step 321.

In step 351, updates in the queue, if any, are grouped by current partition (e.g., as indicated in the entries per hash field 207). In step 353, the count of number of entries per partition is determined for each partition.

In step 355, it is determined whether to review performance statistics so that the partition sizes are chosen to provide good or better performance. If so, then in step 357 thresholds for maximum number of entries per partition are revised based on the latest statistics of performance for the particular index based on size of the partitions. In some embodiments, step 357 is performed by the search statistics module 166. For example, it is assumed for purposes of illustration that it is determined in step 357 that the most populated partitions (e.g., those with the largest number of entries), take three times longer, on average, to process a search than does a partition with half as many entries. In step 357, in this example embodiment, the threshold for the maximum number of entries per partition is dropped below the number of entries in the most populated partitions; and, stored in field 203. Similarly, it is assumed for purposes of illustration that it is determined in step 357 that the least populated partitions (e.g., those with the fewest number of entries), take about the same time, on average, to process a search until a partition has over one million entries. In step 357, in this example embodiment, the threshold for the minimum number of entries per partition is increased above this plateau to about one million entries; and, stored in field 205. Thus, in some embodiments, determining the threshold for the maximum or minimum number of entries is based on past performance of searches of partitions. In some embodiments, the threshold for maximum number of entries per partition is a predetermined fixed amount, or determined by another process, and steps 355 and 357 are omitted.

In step 361, the thresholds that apply are determined, e.g., retrieved from fields 203 and 205. In step 363 the partitions that exceed the maximum thresholds (over-populated) or fall below the minimum thresholds (under-populated) are determined. Thus, step 363 includes, if a number of entries in at least a first partition exceeds a threshold for a maximum number of entries, then determining the next partitions are different from the current partitions. In step 365, it is determined if there is any over-populated or under-populated partitions. If not, the step ends with conditions for retaining the current partitions.

However, if it is determined in step 365 that there is any over-populated or under-populated partitions, then in step 367 conditions to re-partition are satisfied. Control then passes to the following steps.

If not, then in step 373 it is determined whether to keep the current number of partitions. For example, it is determined if the average number of entries per partition is less than a predetermined fraction (e.g., half) of the threshold for maximum and above a predetermined fraction (e.g., 120%) of the minimum threshold, then the current number of partitions are maintained. If so, control passes to step 375. In step 375 the partition boundaries, as defined by the hash value ranges, are changed to reduce the number of entries in the over-populated partitions and increase the number of entries in the under-populated partitions. In some embodiments, step 375 determines a next number of entries in at least the first partition is less than the previous number of entries, or the maximum threshold, by a predetermined fraction, e.g., half. The process 350 then ends.

If it is determined in step 373 not to keep the current number of partitions, then in step 377 it is determined whether to increase the number of partitions. For example, if it is determined that the average number of entries per partition is greater than or equal to the predetermined fraction (e.g., half) of the threshold for maximum, then the number of partitions is increased so that the average number is below the predetermined fraction. If so, control passes to step 379. In step 379 one or more new partitions are added, e.g., one or more over-populated partitions are each split into two or more partitions. Step 379 includes changing the partition boundaries, as defined by the hash value ranges, to reduce the number of entries in the over-populated partitions and increase the number of entries in the newly split-off partitions above the minimum threshold. In some embodiments, repartitioning does not split any specific partition. Instead, the system decides to add n new partitions and then reassigns the partition ranges according to whatever algorithm it uses (that for example, might try to achieve better -more balanced-distribution of entries among the partitions). The reassignment will keep some of the ranges in their current partitions and move some of the ranges to existing or new partitions. The result of the repartitioning process is a new set of partitions, all of them different than the ones before repartitioning. The process 350 then ends.

If it is determined in step 377 not to increase the number of partitions, then the number of partitions is decreased in step 381. In step 381 one or more of the most under-populated partitions are removed, e.g., merged with one or more neighboring partitions. Thus step 381 includes automatically determining the next partitions by, if a current number of partitions is greater than a minimum number of partitions and a number of entries in at least a first partition is below a threshold for a minimum number of entries, then determining a next number of entries such that the next number is greater than the current number of entries. Step 381 includes changing the partition boundaries, as defined by the hash value ranges, to merge adjacent partitions and then to reduce the number of entries in any over-populated partitions after the merger. Step 381 also includes determining whether the next number of entries is greater than the minimum number by a predetermined fraction, e.g., by 20% over the minimum. The process 350 then ends.

Thus, among one or more of steps 375, 379 and 381, the process 350 includes, if the next partitions are different from the current partitions, then automatically determining at least a second entry to store into at least a first partition of the next partitions.

FIG. 4 is a flowchart of a process 400 for enhanced search while updating a partitioned index, according to one embodiment. In one embodiment, the enhanced servlet module 154 in servlets 170 performs the process 400 and is implemented in, for instance, a chip set including a processor and a memory as shown in FIG. 6 or general purpose computer as presented in FIG. 5. In some embodiments, one or more steps are performed by the enhanced node update modules 152 in index nodes 125.

In step 401, the index identifier and the key fields are determined for each index. For example, the index definition data structure 280 is read for one or more indices. In step 403 the hash value ranges for each partition of one or more indices are determined. For example, the entries per hash field 207 of the partition build data structure 297 is read. In step 405 an index node for each partition of each index is determined. For example, the servlets 170 negotiate with each other to assign each partition of each index to a different servlet of the cluster of servlets in round robin fashion. In other embodiments, there is no binding between partitions and servlets. Servlets are dispatched by the load balancer in a round robin fashion and the servlets distribute the request to the servers according to the partition distributions among servers.

In step 407, it is determined whether a published update is received from the build server, e.g., in response to step 333, described above. If so, then in step 409 the update, already separated by partition, is sent to the index nodes for the corresponding partitions, which perform the inserts or deletes or replacements indicated by the published updates.

Control then passes to step 439 to determine whether end conditions are satisfied. If so, the process ends. Otherwise control passes back to step 403 to determine any updated hash partitions.

If a published update is not received, then it is determined in step 411, whether a publication is received of a notice to pull a partition from the active index e.g., in response to step 329, described above. If so, then, in step 413, the index node(s) 125 for the corresponding partition(s) are notified, which pull the partition(s) from the active index and stores a local copy in index partition copy 127. Control then passes to step 429 to check end conditions, as described above.

If a notice to pull a partition is not received, then it is determined in step 421, whether a search request is received, e.g., in response to step 313, described above. If so, then, in step 423, the search is satisfied by one or more index nodes 125 based on data in the index partition copy 127. Thus searches are supported by index nodes 125 even while an index is being updated at the build server 162. For example, this can be true even if the partition's local copy on the data node is being updated because of backend (asynchronous) or front end updates (synchronous) updates. Since the search is supported in the index partition copy 127, step 423 includes supporting the search of the at least second entry in a copy of at least a second (possibly obsolete) partition while at least the second entry is stored into at least the first (e.g., master or active index) partition. For example, the local copies of the partitions may not contain the exact same entries as in their counterparts on the build server but that does not matter. The searches are executed against local copies which may be behind on backend updates and ahead on the front end updates. Control then passes to step 429 to check end conditions, as described above.

If a search request is not received, then it is determined in step 431, whether real-time (synchronous) updates are received, e.g., in response to step 313, described above. If so, then, in step 433, the real time updates are sent to the appropriate one or more index nodes which apply the updates into the index partition copy 127. Thus subsequent searches are supported with these synchronous updates even before the master index is updated. In the illustrated embodiment, the real-time updates are sent to the build sever 162 during step 433 to verify the data and to cause the updates to be entered into the queue for the master index. Control then passes to step 429 to check end conditions, as described above.

The above structures, modules and processes provide a unique framework for creation, management, maintenance and access to the indexes. Indexes are created, partitioned, expanded and shrunk automatically without any manual intervention or requiring any administration. In various embodiments, the system 100 provides the following advantages.

Automatic creation of the index. Indexes are automatically created by the system based on the specifications defined, for example, in the XML format by the network services 110. The services 110 simply define their indices in an XML file and send that to the system 100 via some public API and the indices are validated and created completely automatically. Once the indices are created, they can be loaded with data through the system's load API. None of these functions require any manual intervention. The creation, distribution and management of the partitions are all done automatically.

Automatic Re-partitioning of the index. When the index is grown to a certain size that it starts affecting the performance, the system automatically adds new partitions and rebalances the data across partitions without affecting the searches at all. The re-partitioning can happen also when the index becomes smaller and partitions are removed from the index.

Lazy/delayed reopening the searches. On the index nodes, after applying the incremental updates to each partition, a new searcher is opened for the updates to be visible to the customers. The system 100 employs an algorithm to delay the reopening of the searcher to boost performance. The amount of the delay is determined dynamically according to the SLA numbers. The system also dynamically collects statistics on how long it takes to open the searcher and uses that information to determine the amount of the delay.

Automatic failover. When a failure occurs, e.g. an index node fails, the system 100 automatically moves the responsibility of all the partitions that the failed node used to have to other index nodes in the cluster and this shift of the responsibility has minimal effect on the customer, the network services 110 and clients on UE 101.

High Availability. On top of automatic failover, high availability is provided through partitioning and distribution of the partitions across multiple physical machines. The partitioning and distribution of index data provides high-availability as follows. When a host of a servlet goes down, even during the failover, only the portion of the index that is served by that host becomes unavailable. For instance, consider an index that is divided into 20 partitions, each partition served by a different host in the cluster. If one of the servers or hosts goes down, the failover process kicks in and the failed partition is recovered by another server on another host. While the failover process is being completed, 19 other partitions of the index are still available and are being served for the requests that are received for the index. Some of the requests are completely satisfied and some might be partly satisfied but the index is available and being served even during failover. Some Partitions may be replicated. The replication also boosts availability of the index. If a server fails, the responsibility of serving the partitions of that server is shifted to the server that has the replica of the partitions. Each partition on the index nodes, where they're being served, is backed up by a master copy that lives on a shared, redundant and highly available file system. If a server fails, the partitions that the server is responsible for can be served by other servers in the cluster from this shared file system while the failover process is in progress.

High Performance for Index Updates and Searches. The system 100 provides two paths for updating the index: 1, bulk asynchronous; and 2, small synchronous. The first path is for larger updates to the index that have less stringent latency requirements. The design allows both types of updates to be applied to the index segments while the index is served for searches. Batching/buffering techniques for the updates on the build server and lazy opening of the searchers on the data nodes allows for fast updates to the index while the same index is being searched.

The system 100 provides a distributed platform that customers made up of services 110 can use to store and search their data with minimal amount of administration. This is a shared environment that provides reliability, availability and performance for users' data at services 110 to levels that are not easily achievable, otherwise.

The processes described herein for updating of a partitioned index may be advantageously implemented via software, hardware, firmware or a combination of software and/or firmware and/or hardware. For example, the processes described herein may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

FIG. 5 illustrates a computer system 500 upon which an embodiment of the invention may be implemented. Although computer system 500 is depicted with respect to a particular device or equipment, it is contemplated that other devices or equipment (e.g., network elements, servers, etc.) within FIG. 5 can deploy the illustrated hardware and components of system 500. Computer system 500 is programmed (e.g., via computer program code or instructions) to process search requests directed to a partitioned index as described herein and includes a communication mechanism such as a bus 510 for passing information between other internal and external components of the computer system 500. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 500, or a portion thereof, constitutes a means for performing one or more steps of updating of a partitioned index.

A bus 510 includes one or more parallel conductors of information so that information is transferred quickly among devices coupled to the bus 510. One or more processors 502 for processing information are coupled with the bus 510.

A processor (or multiple processors) 502 performs a set of operations on information as specified by computer program code related to updating of a partitioned index. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 510 and placing information on the bus 510. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 502, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 500 also includes a memory 504 coupled to bus 510. The memory 504, such as a random access memory (RAM) or other dynamic storage device, stores information including processor instructions for updating of a partitioned index. Dynamic memory allows information stored therein to be changed by the computer system 500. RAM allows a unit of information stored at a location called a memory address to be stored and retrieved independently of information at neighboring addresses. The memory 504 is also used by the processor 502 to store temporary values during execution of processor instructions. The computer system 500 also includes a read only memory (ROM) 506 or other static storage device coupled to the bus 510 for storing static information, including instructions, that is not changed by the computer system 500. Some memory is composed of volatile storage that loses the information stored thereon when power is lost. Also coupled to bus 510 is a non-volatile (persistent) storage device 508, such as a magnetic disk, optical disk or flash card, for storing information, including instructions, that persists even when the computer system 500 is turned off or otherwise loses power.

Information, including instructions for updating of a partitioned index, is provided to the bus 510 for use by the processor from an external input device 512, such as a keyboard containing alphanumeric keys operated by a human user, or a sensor. A sensor detects conditions in its vicinity and transforms those detections into physical expression compatible with the measurable phenomenon used to represent information in computer system 500. Other external devices coupled to bus 510, used primarily for interacting with humans, include a display device 514, such as a cathode ray tube (CRT) or a liquid crystal display (LCD), or plasma screen or printer for presenting text or images, and a pointing device 516, such as a mouse or a trackball or cursor direction keys, or motion sensor, for controlling a position of a small cursor image presented on the display 514 and issuing commands associated with graphical elements presented on the display 514. In some embodiments, for example, in embodiments in which the computer system 500 performs all functions automatically without human input, one or more of external input device 512, display device 514 and pointing device 516 is omitted.

In the illustrated embodiment, special purpose hardware, such as an application specific integrated circuit (ASIC) 520, is coupled to bus 510. The special purpose hardware is configured to perform operations not performed by processor 502 quickly enough for special purposes. Examples of application specific ICs include graphics accelerator cards for generating images for display 514, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 500 also includes one or more instances of a communications interface 570 coupled to bus 510. Communication interface 570 provides a one-way or two-way communication coupling to a variety of external devices that operate with their own processors, such as printers, scanners and external disks. In general the coupling is with a network link 578 that is connected to a local network 580 to which a variety of external devices with their own processors are connected. For example, communication interface 570 may be a parallel port or a serial port or a universal serial bus (USB) port on a personal computer. In some embodiments, communications interface 570 is an integrated services digital network (ISDN) card or a digital subscriber line (DSL) card or a telephone modem that provides an information communication connection to a corresponding type of telephone line. In some embodiments, a communication interface 570 is a cable modem that converts signals on bus 510 into signals for a communication connection over a coaxial cable or into optical signals for a communication connection over a fiber optic cable. As another example, communications interface 570 may be a local area network (LAN) card to provide a data communication connection to a compatible LAN, such as Ethernet. Wireless links may also be implemented. For wireless links, the communications interface 570 sends or receives or both sends and receives electrical, acoustic or electromagnetic signals, including infrared and optical signals, that carry information streams, such as digital data. For example, in wireless handheld devices, such as mobile telephones like cell phones, the communications interface 570 includes a radio band electromagnetic transmitter and receiver called a radio transceiver. In certain embodiments, the communications interface 570 enables connection to the communication network 105 for updating of a partitioned index to the UE 101.

The term “computer-readable medium” as used herein refers to any medium that participates in providing information to processor 502, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 508. Volatile media include, for example, dynamic memory 504. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 520.

Network link 578 typically provides information communication using transmission media through one or more networks to other devices that use or process the information. For example, network link 578 may provide a connection through local network 580 to a host computer 582 or to equipment 584 operated by an Internet Service Provider (ISP). ISP equipment 584 in turn provides data communication services through the public, world-wide packet-switching communication network of networks now commonly referred to as the Internet 590.

A computer called a server host 592 connected to the Internet hosts a process that provides a service in response to information received over the Internet. For example, server host 592 hosts a process that provides information representing video data for presentation at display 514. It is contemplated that the components of system 500 can be deployed in various configurations within other computer systems, e.g., host 582 and server 592.

At least some embodiments of the invention are related to the use of computer system 500 for implementing some or all of the techniques described herein. According to one embodiment of the invention, those techniques are performed by computer system 500 in response to processor 502 executing one or more sequences of one or more processor instructions contained in memory 504. Such instructions, also called computer instructions, software and program code, may be read into memory 504 from another computer-readable medium such as storage device 508 or network link 578. Execution of the sequences of instructions contained in memory 504 causes processor 502 to perform one or more of the method steps described herein. In alternative embodiments, hardware, such as ASIC 520, may be used in place of or in combination with software to implement the invention. Thus, embodiments of the invention are not limited to any specific combination of hardware and software, unless otherwise explicitly stated herein.

The signals transmitted over network link 578 and other networks through communications interface 570, carry information to and from computer system 500. Computer system 500 can send and receive information, including program code, through the networks 580, 590 among others, through network link 578 and communications interface 570. In an example using the Internet 590, a server host 592 transmits program code for a particular application, requested by a message sent from computer 500, through Internet 590, ISP equipment 584, local network 580 and communications interface 570. The received code may be executed by processor 502 as it is received, or may be stored in memory 504 or in storage device 508 or other non-volatile storage for later execution, or both. In this manner, computer system 500 may obtain application program code in the form of signals on a carrier wave.

Various forms of computer readable media may be involved in carrying one or more sequence of instructions or data or both to processor 502 for execution. For example, instructions and data may initially be carried on a magnetic disk of a remote computer such as host 582. The remote computer loads the instructions and data into its dynamic memory and sends the instructions and data over a telephone line using a modem. A modem local to the computer system 500 receives the instructions and data on a telephone line and uses an infra-red transmitter to convert the instructions and data to a signal on an infra-red carrier wave serving as the network link 578. An infrared detector serving as communications interface 570 receives the instructions and data carried in the infrared signal and places information representing the instructions and data onto bus 510. Bus 510 carries the information to memory 504 from which processor 502 retrieves and executes the instructions using some of the data sent with the instructions. The instructions and data received in memory 504 may optionally be stored on storage device 508, either before or after execution by the processor 502.

FIG. 6 illustrates a chip set or chip 600 upon which an embodiment of the invention may be implemented. Chip set 600 is programmed to process search requests directed to a partitioned index as described herein and includes, for instance, the processor and memory components described with respect to FIG. 5 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 600 can be implemented in a single chip. It is further contemplated that in certain embodiments the chip set or chip 600 can be implemented as a single “system on a chip.” It is further contemplated that in certain embodiments a separate ASIC would not be used, for example, and that all relevant functions as disclosed herein would be performed by a processor or processors. Chip set or chip 600, or a portion thereof, constitutes a means for performing one or more steps of providing user interface navigation information associated with the availability of functions. Chip set or chip 600, or a portion thereof, constitutes a means for performing one or more steps of updating of a partitioned index.

In one embodiment, the chip set or chip 600 includes a communication mechanism such as a bus 601 for passing information among the components of the chip set 600. A processor 603 has connectivity to the bus 601 to execute instructions and process information stored in, for example, a memory 605. The processor 603 may include one or more processing cores with each core configured to perform independently. A multi-core processor enables multiprocessing within a single physical package. Examples of a multi-core processor include two, four, eight, or greater numbers of processing cores. Alternatively or in addition, the processor 603 may include one or more microprocessors configured in tandem via the bus 601 to enable independent execution of instructions, pipelining, and multithreading. The processor 603 may also be accompanied with one or more specialized components to perform certain processing functions and tasks such as one or more digital signal processors (DSP) 607, or one or more application-specific integrated circuits (ASIC) 609. A DSP 607 typically is configured to process real-world signals (e.g., sound) in real time independently of the processor 603. Similarly, an ASIC 609 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 600 includes merely one or more processors and some software and/or firmware supporting and/or relating to and/or for the one or more processors.

The processor 603 and accompanying components have connectivity to the memory 605 via the bus 601. The memory 605 includes both dynamic memory (e.g., RAM, magnetic disk, writable optical disk, etc.) and static memory (e.g., ROM, CD-ROM, etc.) for storing executable instructions that when executed perform the inventive steps described herein to process search requests directed to a partitioned index. The memory 605 also stores the data associated with or generated by the execution of the inventive steps.

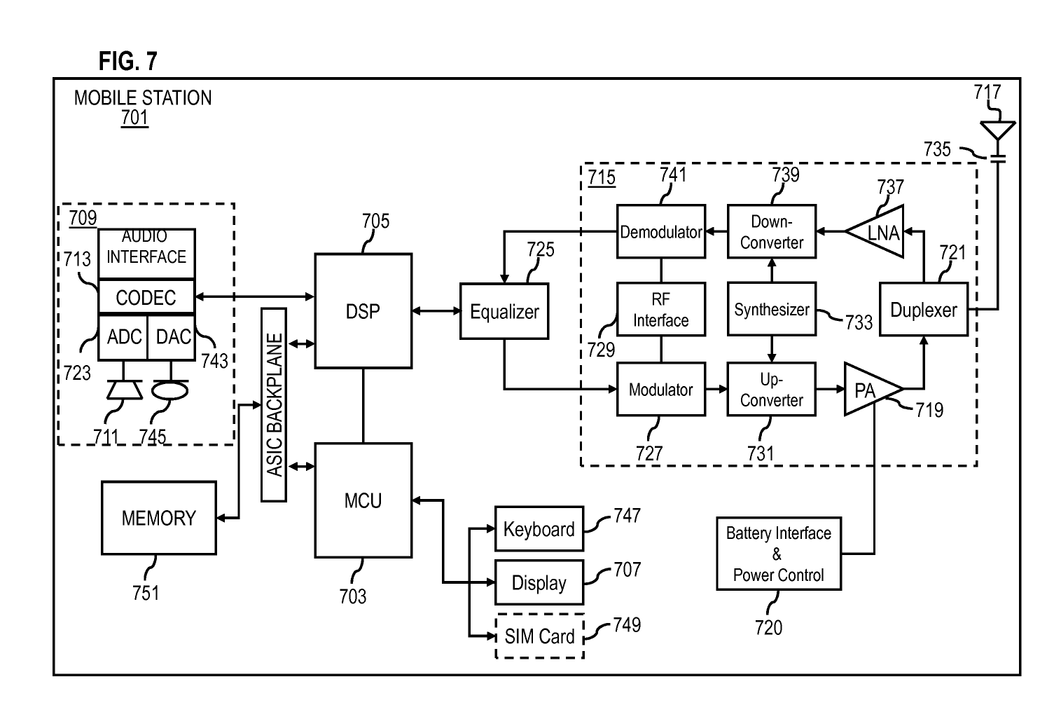

FIG. 7 is a diagram of exemplary components of a mobile terminal (e.g., handset) for communications, which is capable of operating in the system of FIG. 1, according to one embodiment. In some embodiments, mobile terminal 701, or a portion thereof, constitutes a means for performing one or more steps of updating of a partitioned index. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 703, a Digital Signal Processor (DSP) 705, and a receiver/transmitter unit including a microphone gain control unit and a speaker gain control unit. A main display unit 707 provides a display to the user in support of various applications and mobile terminal functions that perform or support the steps of updating of a partitioned index. The display 707 includes display circuitry configured to display at least a portion of a user interface of the mobile terminal (e.g., mobile telephone). Additionally, the display 707 and display circuitry are configured to facilitate user control of at least some functions of the mobile terminal. An audio function circuitry 709 includes a microphone 711 and microphone amplifier that amplifies the speech signal output from the microphone 711. The amplified speech signal output from the microphone 711 is fed to a coder/decoder (CODEC) 713.

A radio section 715 amplifies power and converts frequency in order to communicate with a base station, which is included in a mobile communication system, via antenna 717. The power amplifier (PA) 719 and the transmitter/modulation circuitry are operationally responsive to the MCU 703, with an output from the PA 719 coupled to the duplexer 721 or circulator or antenna switch, as known in the art. The PA 719 also couples to a battery interface and power control unit 720.

In use, a user of mobile terminal 701 speaks into the microphone 711 and his or her voice along with any detected background noise is converted into an analog voltage. The analog voltage is then converted into a digital signal through the Analog to Digital Converter (ADC) 723. The control unit 703 routes the digital signal into the DSP 705 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 725 for compensation of any frequency-dependent impairments that occur during transmission though the air such as phase and amplitude distortion. After equalizing the bit stream, the modulator 727 combines the signal with a RF signal generated in the RF interface 729. The modulator 727 generates a sine wave by way of frequency or phase modulation. In order to prepare the signal for transmission, an up-converter 731 combines the sine wave output from the modulator 727 with another sine wave generated by a synthesizer 733 to achieve the desired frequency of transmission. The signal is then sent through a PA 719 to increase the signal to an appropriate power level. In practical systems, the PA 719 acts as a variable gain amplifier whose gain is controlled by the DSP 705 from information received from a network base station. The signal is then filtered within the duplexer 721 and optionally sent to an antenna coupler 735 to match impedances to provide maximum power transfer. Finally, the signal is transmitted via antenna 717 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 701 are received via antenna 717 and immediately amplified by a low noise amplifier (LNA) 737. A down-converter 739 lowers the carrier frequency while the demodulator 741 strips away the RF leaving only a digital bit stream. The signal then goes through the equalizer 725 and is processed by the DSP 705. A Digital to Analog Converter (DAC) 743 converts the signal and the resulting output is transmitted to the user through the speaker 745, all under control of a Main Control Unit (MCU) 703—which can be implemented as a Central Processing Unit (CPU) (not shown).

The MCU 703 receives various signals including input signals from the keyboard 747. The keyboard 747 and/or the MCU 703 in combination with other user input components (e.g., the microphone 711) comprise a user interface circuitry for managing user input. The MCU 703 runs a user interface software to facilitate user control of at least some functions of the mobile terminal 701 to process search requests directed to a partitioned index. The MCU 703 also delivers a display command and a switch command to the display 707 and to the speech output switching controller, respectively. Further, the MCU 703 exchanges information with the DSP 705 and can access an optionally incorporated SIM card 749 and a memory 751. In addition, the MCU 703 executes various control functions required of the terminal. The DSP 705 may, depending upon the implementation, perform any of a variety of conventional digital processing functions on the voice signals. Additionally, DSP 705 determines the background noise level of the local environment from the signals detected by microphone 711 and sets the gain of microphone 711 to a level selected to compensate for the natural tendency of the user of the mobile terminal 701.

The CODEC 713 includes the ADC 723 and DAC 743. The memory 751 stores various data including call incoming tone data and is capable of storing other data including music data received via, e.g., the global Internet. The software module could reside in RAM memory, flash memory, registers, or any other form of writable storage medium known in the art. The memory device 751 may be, but not limited to, a single memory, CD, DVD, ROM, RAM, EEPROM, optical storage, or any other non-volatile storage medium capable of storing digital data.

An optionally incorporated SIM card 749 carries, for instance, important information, such as the cellular phone number, the carrier supplying service, subscription details, and security information. The SIM card 749 serves primarily to identify the mobile terminal 701 on a radio network. The card 749 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising facilitating a processing of and/or processing (1) data and/or (2) information and/or (3) at least one signal, the (1) data and/or (2) information and/or (3) at least one signal based, at least in part, on the following:
first data that indicates a plurality of fields for each entry in an index for a data store;
at least one determination of current partitions for the index;
second data that indicates at least one value for at least one field of at least a first entry in the index; and
at least one determination of next partitions for the index based on the second data.

2. A method of claim 1, wherein the (1) data and/or (2) information and/or (3) at least one signal are further based, at least in part, on the following:
if the next partitions are different from the current partitions, then at least one determination of at least a second entry to store into at least a first partition of the next partitions.

3. A method of claim 2, wherein the (1) data and/or (2) information and/or (3) at least one signal are further based, at least in part, on the following:
if the next partitions are different from the current partitions, then a supporting of a search of at least the second entry before at least the second entry is stored into at least the first partition.

4. A method of claim 3, wherein the supporting the search of at least the second entry before at least the second entry is stored into at least the first partition causes the (1) data and/or (2) information and/or (3) at least one signal to be further based, at least in part, on:
a supporting of the search of the at least second entry in a copy of at least a second partition while at least the second entry is stored into at least the first partition.

5. A method of claim 5, wherein the (1) data and/or (2) information and/or (3) at least one signal are further based, at least in part, on the following:
after at least the second entry is stored into at least the first partition, a propagation of the change to the copy of at least the second partition.

6. A method of claim 5, wherein the (1) data and/or (2) information and/or (3) at least one signal are further based, at least in part, on the following:
if at least the second partition is different from at least the first partition, then, after at least the second entry is stored into at least the first partition, a propagation of the change to a copy of at least the first partition.

7. A method of claim 1, wherein the at least one determination of the next partitions causes the (1) data and/or (2) information and/or (3) at least one signal to be further based, at least in part, on:
if a number of entries in at least a first partition exceeds a threshold for a maximum number of entries, then at least one determination that the next partitions are different from the current partitions.

8. A method of claim 7, wherein the (1) data and/or (2) information and/or (3) at least one signal are further based, at least in part, on the following:
at least one determination of the threshold for the maximum number of entries based, at least in part, on past performance of searches of partitions.

9. A method of claim 7, wherein a next number of entries in at least the first partition is less than the number of entries by a predetermined fraction.

10. A method of claim 1, wherein the at least one determination of the next partitions causes the (1) data and/or (2) information and/or (3) at least one signal to be further based, at least in part, on:
if a current number of partitions is greater than a minimum number of partitions and a number of entries in at least a first partition is below a threshold for a minimum number of entries, then at least one determination of a next number of entries such that the next number is greater than the number of entries.

11. A method of claim 10, wherein the (1) data and/or (2) information and/or (3) at least one signal are further based, at least in part, on the following:
at least one determination of the threshold for the minimum number of entries based on past performance of searches of partitions.

12. A method of claim 10, wherein the next number of entries is greater than the minimum number by a predetermined fraction.

13. A method of claim 1, wherein the (1) data and/or (2) information and/or (3) at least one signal are further based, at least in part, on the following:
at least one determination to store the second data into at least a first partition of the next number of partitions.

14. A method of claim 13, wherein the (1) data and/or (2) information and/or (3) at least one signal are further based, at least in part, on the following:
a supporting of a search of at least the first entry before at least the first entry is stored into at least the first partition.

15. A method of claim 14, wherein the supporting the search of at least the first entry before at least the first entry is stored into at least the first partition causes the (1) data and/or (2) information and/or (3) at least one signal to be further based, at least in part, on:
a supporting of the search of the at least first entry in a copy of at least the first partition while at least the first entry is stored into at least the first partition.

16. A method of claim 15, wherein the (1) data and/or (2) information and/or (3) at least one signal are further based, at least in part, on the following:
after at least the first entry is stored into at least the first partition, a propagation of the change to the copy of at least the first partition.

17. A method of claim 16, wherein the propagation of the change to the copy of at least the first partition is performed within about 30 seconds of receiving the second data.

18. A method of claim 15, wherein the (1) data and/or (2) information and/or (3) at least one signal are further based, at least in part, on the following:
if the second data indicates the at least one value for the at least one field of no more than a ceiling number of entries, then before at least the first entry is stored into at least the first partition, a storing of at least the first entry into the copy of at least the first partition.

19. A method of claim 18, wherein the (1) data and/or (2) information and/or (3) at least one signal are further based, at least in part, on the following:
at least one determination of the ceiling number of entries based on a time to store at least the ceiling number of entries into the copy of at least the first partition, such that the time is less than a maximum time of about 1 second.

20. An apparatus comprising:
at least one processor; and
at least one memory including computer program code for one or more programs,
the at least one memory and the computer program code configured to, with the at least one processor, cause the apparatus to perform at least the steps of one any one of claims 1-19.
